(19) United States
(12) Patent Application Publication
(10) Pub. No.: US 2012/0095687 A1
(43) Pub. Date: Apr. 19, 2012

(54) METHOD OF PREDICTING SOURCE ROCK THERMAL MATURITY FROM LOG RESPONSES

(75) Inventor: Brian LeCompte, Cypress, TX (US)

(73) Assignee: BAKER HUGHES INCORPORATED, Houston, TX (US)

(21) Appl. No.: 13/086,969

(22) Filed: Apr. 14, 2011

Related U.S. Application Data
(60) Provisional application No. 61/326,353, filed on Apr. 21, 2010.

(51) Int. Cl. G06F 19/00; G01V 5/06

(52) U.S. Cl. 702/7; 702/6; 702/8

(57) ABSTRACT

A method for estimating a property of an earth formation, the method includes: conveying a carrier through a borehole penetrating the earth formation; performing a measurement of total organic carbon (TOC) within a region of investigation in the earth formation using a logging tool disposed at the carrier; and correlating the measured TOC to the property to estimate the property.

### CROSS REFERENCE TO RELATED APPLICATIONS

This application claims the benefit of an earlier filing date from U.S. Provisional Application Ser. No. 61/326,353 filed Apr. 21, 2010, the entire disclosure of which is incorporated herein by reference.

### BACKGROUND OF THE INVENTION

1. Field of the Invention

The present invention relates to estimating a property of rocks in an earth formation using responses from measurements performed in a borehole penetrating the earth formation.

2. Description of the Related Art

In the exploration and production of hydrocarbons, it is important to know properties of rocks in an earth formation that may contain reservoirs of the hydrocarbons. Petroleum source rocks can be classified according to their level of thermal maturity. Thermal maturity can range from very low to high maturity levels and determines the extent of conversion of kerogen into hydrocarbons. Hence, it is important to know the level of thermal maturity of source rocks in an earth formation in order to efficiently use exploration and production resources.

The type of organic matter present in a source rock, time, and temperature to which it has been exposed determine the type of hydrocarbons the source rock contains. The thermal maturity of source rocks can be measured in a laboratory by heating the sample and measuring the carbon expelled. The measurements are then plotted on a familiar scale to indicate the level of thermal maturity of the source rock.

The production of oil and gas from source rocks has become increasingly profitable in North America. Often in a given gas shale or oil shale formation, such as the Barnett shale, oil and gas may both be present in different areas of the basin. It is essential for operators to evaluate whether as source rock formation will produce oil or gas since completion decisions are directly affected by this knowledge.

Core analysis is one way to determine the level of thermal maturity of source rocks. In general, core analysis can be performed on whole cores, rotary cores, or sidewall cores if taken. Unfortunately, cores are not always taken and if they are, then it may take a considerable amount of time to perform the analysis.

Measurements of properties of the source rocks in an earth formation can be performed using a technique referred to as well logging. In well logging, a logging instrument or tool configured to perform the measurements is conveyed through a borehole penetrating the earth formation. The tool is supported by a wireline in one embodiment or disposed at a drillstring drilling the borehole in another embodiment referred to as logging-while-drilling (LWD). The measurements are associated with a depth at which they were performed to produce a log. While many different types of measurements are performed in well logging, none of the conventional logging tools can measure the level of thermal maturity of the source rocks.

Therefore, what are needed are techniques to measure the level of thermal maturity of source rocks without requiring a core analysis.

### BRIEF SUMMARY OF THE INVENTION

Disclosed is a method for estimating a property of an earth formation, the method includes: conveying a carrier through a borehole penetrating the earth formation; performing a measurement of total organic carbon (TOC) within a region of investigation in the earth formation using a logging tool disposed at the carrier; and correlating the measured TOC to the property to estimate the property.

Also disclosed is an apparatus for estimating a property of an earth formation, the apparatus includes: a carrier configured to be conveyed through a borehole penetrating the earth formation; a logging tool disposed at the carrier and configured to perform a measurement of total organic carbon (TOC) within a region of investigation in the earth formation; and a processor configured to correlate the measurement of TOC to the property to estimate the property.

Further disclosed is a non-transitory computer-readable storage medium comprising computer-executable instructions for estimating a property of an earth formation by implementing a method includes: receiving a measurement of total organic carbon (TOC) in the earth formation using a logging tool conveyed through a borehole penetrating the earth formation; and correlating the measured TOC to the property to estimate the property.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates an exemplary embodiment of a logging tool disposed in a borehole penetrating an earth formation;

FIG. 2 illustrates a correlation between level of maturity (LOM) of a source rock and the vitrinite reflectance of the source rock;

FIG. 3 illustrates a log displaying a calculated vitrinite reflectance of a Barnett Shale section from an oil window;

FIG. 4 illustrates a log displaying a calculated vitrinite reflectance in a dry gas section of a Woodford Shale section;

FIG. 5 illustrates correlations between total organic carbon (TOC), S2, and LOM for oil prone source rocks;

FIG. 6 illustrates correlations between TOC, S2, and LOM for gas prone source rocks;

FIG. 7 illustrates a derived correlation between hydrogen index and LOM for gas prone source rocks; and

FIG. 8 presents one example of a method for estimating a property of a source rock disposed in an earth formation.

### DETAILED DESCRIPTION OF THE INVENTION

Disclosed are exemplary embodiments of techniques for estimating a level of thermal maturity or LOM of a source rock in an earth formation. The techniques, which include apparatus and method, call for measuring the total organic carbon (TOC) of the source rock directly using a logging tool such as a pulsed-neutron logging tool. Using a correlation between the LOM and TOC, the LOM can be determined and plotted along with other measurements on a well log. In addition, other properties can also be estimated from the TOC measurements using other correlations. One other property is S2, which is an amount of hydrocarbons generated from cracking of kerogen in source rock when the sample temperature is raised to 550 degrees Celsius in a prolysis, usually given per mass of source rock. Another property is a hydrogen index. The hydrogen index is the ratio of the S2 in mg HC/g rock to the TOC in weight percent. An alternative term for the hydrogen index is hydrocarbon index.

Several correlations have been published that relate the amount of TOC to conventional logging responses. For example, see Passey et al. (Passey, Q., Creaney, S., Kula, J., Moretti, F., Stroud, J.,: “A Practical Model for Organic Richness from Porosity and Resistivity Logs,” AAPG Bulletin, Vol. 74, No. 12, pp 1777-1794, 1990). The method proposed by Passey et al. uses an overlay technique to determine a separation, called Δ Log R (or D Log R), between an acoustic log and a resistivity log to determine the TOC. This method relies on prior knowledge about the LOM of the source rock. The LOM of the source rock for the Passey et al. method is normally measured with core analysis and assumed for an interval.

New pulsed neutron logging devices and methods as described by Pemper et al. (2006) and Pemper et al. (2009) (referring to Pemper et al.: “A New Pulsed Neutron Sonde for Derivation of Formation Lithology and Mineralogy,” Paper SPE 102770, Trans., SPE Annual Technical Conference and Exhibition, San Antonio, Tex., 2006 and Pemper et al.: “The Direct Measurement of Carbon in Wells Containing Oil and Natural Gas Using a Pulsed Neutron Mineralogy Tool,” Paper SPE 124234, Trans., SPE Annual Technical Conference and Exhibition, New Orleans, La., 2009) can directly measure the TOC of source rocks. For example, carbon produces gamma rays from inelastic scattering of neutrons in the formation. The inelastic gamma rays are measured as part of a logging device and processing method. Calcium, iron and magnesium are also measured. The amount of carbon related to the organic matter only can be separated from the carbon in the carbonates as disclosed by Pemper et al. (2009). The remaining carbon is then considered the TOC when source rock conditions are indicated from other elemental indications such as high uranium content relative to thorium.

When a geochemical log measurement of TOC is not available, the TOC can be correlated to measurements of bulk density, natural gamma rays, or uranium.

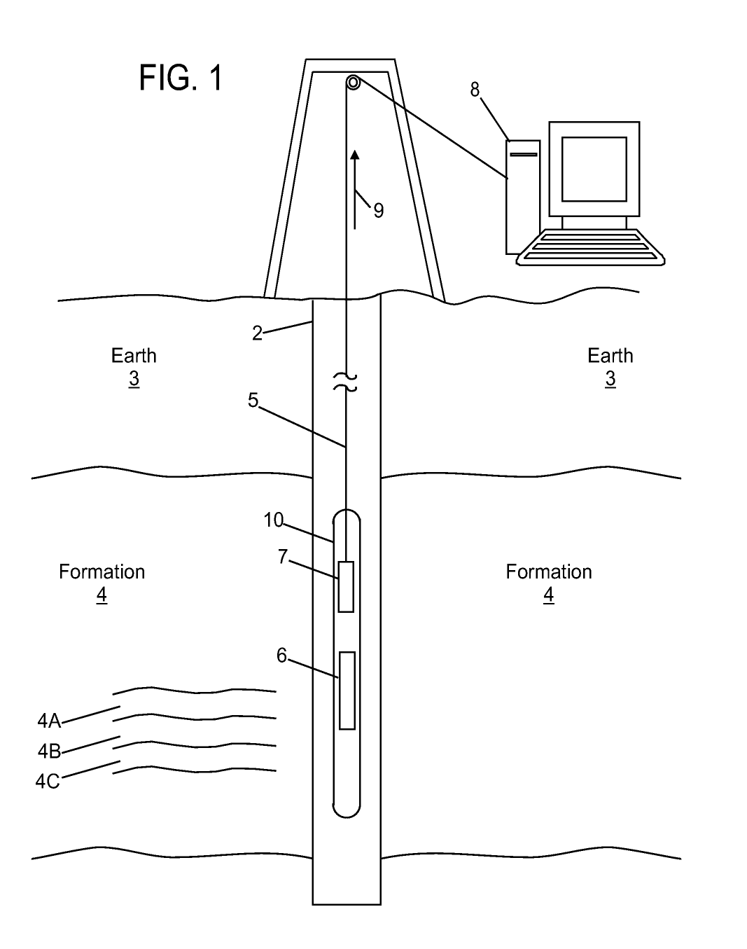

Reference may now be had to FIG. 1 illustrating an exemplary embodiment of a logging tool 10 disposed in a borehole 2 penetrating the Earth 3. The Earth 3 includes a formation 4 that can include layers 4A-4C. The formation 4 represents sub-surface materials of interest of which a property is to be estimated. The logging tool 10 is configured to perform measurements of the formation 4 as a function of depth to produce a log of the measurements.

Still referring to FIG. 1, the logging tool 10 is supported by an armored cable 5 used to convey the logging tool 10 through the borehole 2 in a technique referred to as wireline logging. The borehole 2 may be cased or open. In addition to acting as a conveyance device, the wireline 5, which can also be a slickline, can also provide for communications between the tool 10 and equipment at the surface of the Earth 3. In another embodiment, the logging tool 10 is configured to perform the measurements while the borehole 2 is being drilled or during a temporary halt in drilling in a technique referred to as logging-while-drilling (LWD). In LWD embodiments, the logging tool 10 is conveyed through the borehole 2 by a drillstring or coiled tubing.

In order to perform a measurement of the formation 4, the logging tool 10 includes various logging components 6. Non-limiting embodiments of the logging components 6 include: a natural radiation detector configured to measure natural radiation emitted from the formation 4; a neutron source configured to irradiate the formation 4 with neutrons; at least one radiation detector configured to measure radiation resulting from inelastic scattering of at least some of the neutrons from the neutron source by the formation 4 and/or radiation resulting from the thermal absorption by the formation 4 of at least some of the neutrons from the neutron source; an acoustic transmitter configured to transmit acoustic energy into the formation 4; an acoustic receiver configured to receive acoustic energy from the earth formation resulting from the transmitted acoustic energy; a transmitter configured to transmit electric or electromagnetic energy into the formation 4; and a receiver configured to receive electric or electromagnetic energy from the formation 4 due to the transmitted electric or electromagnetic energy. In general, the above components may be used to form a natural radiation logging tool, a neutron logging tool (e.g., density or porosity tool), an acoustic logging tool, and/or a resistivity logging tool. All or these tools or some combination of these tools may be present, as in a string of tools, in the logging tool 10. If one logging tool in unavailable, then another logging tool may be used in its place. For example, if an acoustic logging tool is unavailable, then a log from a density tool or a porosity tool may be used in place of an acoustic log.

The components 6 either individually or in combination are configured to identify and/or quantify elements in the formation 4, measure porosity of the formation 4, measure the bulk density of the formation 4, measure natural radiation emitted by the formation 4, measure uranium in the formation 4, measure inelastic scattering radiation emitted from the formation 4, and measure thermal neutron capture radiation emitted from the formation 4. With the measurements and data provided by the components 6, a processor can be used to measure the TOC of the formation 4.

The components 6 can be disposed at one logging tool 10 or at more than one logging tool 10. Each tool 10 can produce a log of the measurements performed as a function of depth. When more than one tool 10 is used, measurements from each log can be aligned by depth with the other logs to provide a composite log. The composite log can thus be used to measure the TOC.

Still referring to FIG. 1, the logging tool 10 includes downhole electronics 7. The downhole electronics 7 are configured to at least one of operate the logging tool 10 and receive measurement data 9 from the components 6 for storage and/or transmission to a surface processing unit 8. The surface processing unit 8 is configured to receive and process the measurement data 9 and present the processed data in the form of a log to a petro-analyst or other user.

Processing the measurement data obtained from the logging tool 10 to estimate LOM, S2, and the hydrogen index is now discussed. Equation (1) from Passey et al. relates TOC to Δ Log R and LOM.

TOC=(Δ Log R)*10^{(2.297-0.1688*LOM)} (1)

As disclosed herein, Equation (2) can be derived from Equation (1).

LOM=13.6078−5.924*(log₁₀(TOC/Δ Log R)) (2)

Thus, LOM can be determined if TOC and Δ Log R are measured separately.

One indicator of the LOM of a source rock is referred to as vitrinite reflectance (Ro). Conventionally, Ro is measured in a laboratory as part of a core analysis. One benefit of the techniques disclosed herein is the Ro of a source rock is measured downhole without the need for extraction of a core.

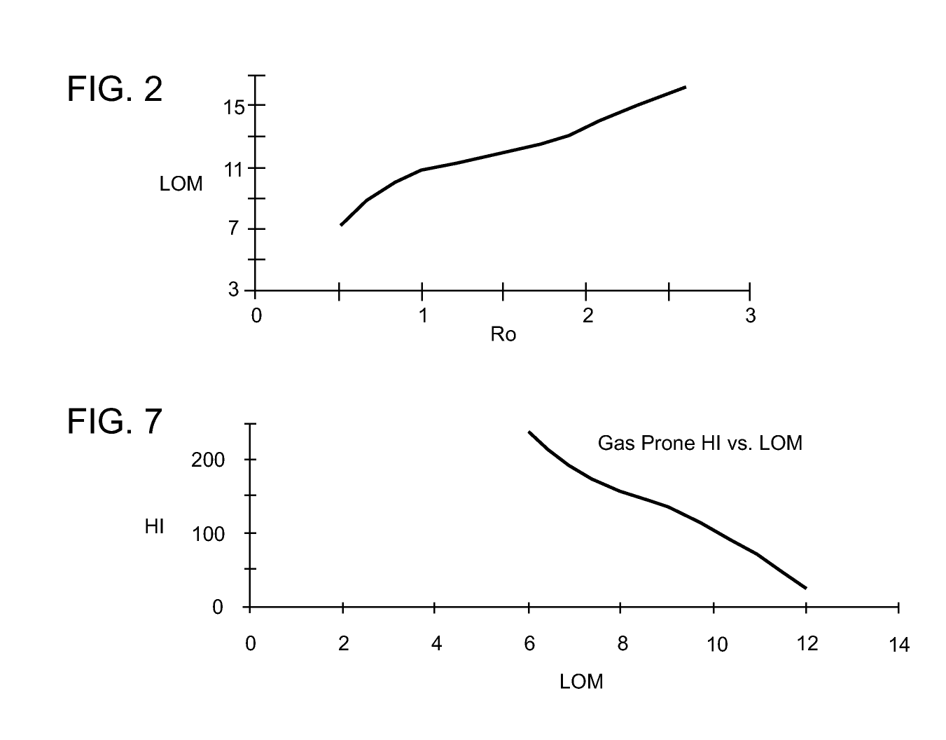

Hood et al. (see Hood, A., Gutjahr, C., Heacock, R., “Organic Metamorphism and the Generation of Petroleum,” The American Association of Petroleum Geologists Bulletin, Vol. 59, No. 6, June 1975) established a relationship between vitrinite reflectance and LOM as shown in FIG. 2. The relationship between Ro and LOM can be described by a polynomial fit as presented in Equation (3).

Ro=−3.288*10⁻⁴*(LOM)⁴+0.0099*(LOM)³−0.0606*(LOM)²−0.1981*(LOM)+2.275 (3)

In the logging environment, a continuous measurement of TOC is available from pulsed neutron logging devices as described above or from correlations using, for example, a uranium log, a density log, or combination of log responses. Similarly, a continuous log of Δ Log R is available from a resistivity log and at least one of a sonic (acoustic) log, a density log, and a neutron porosity log. Hence, a continuous log of LOM of organic matter in an earth formation can be produced.

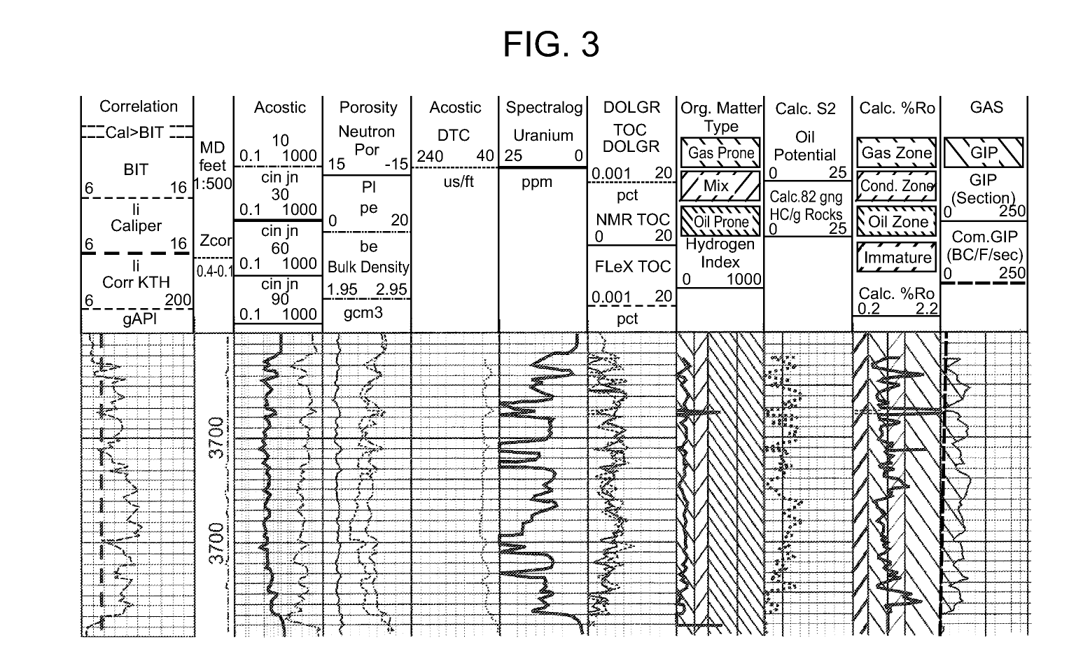

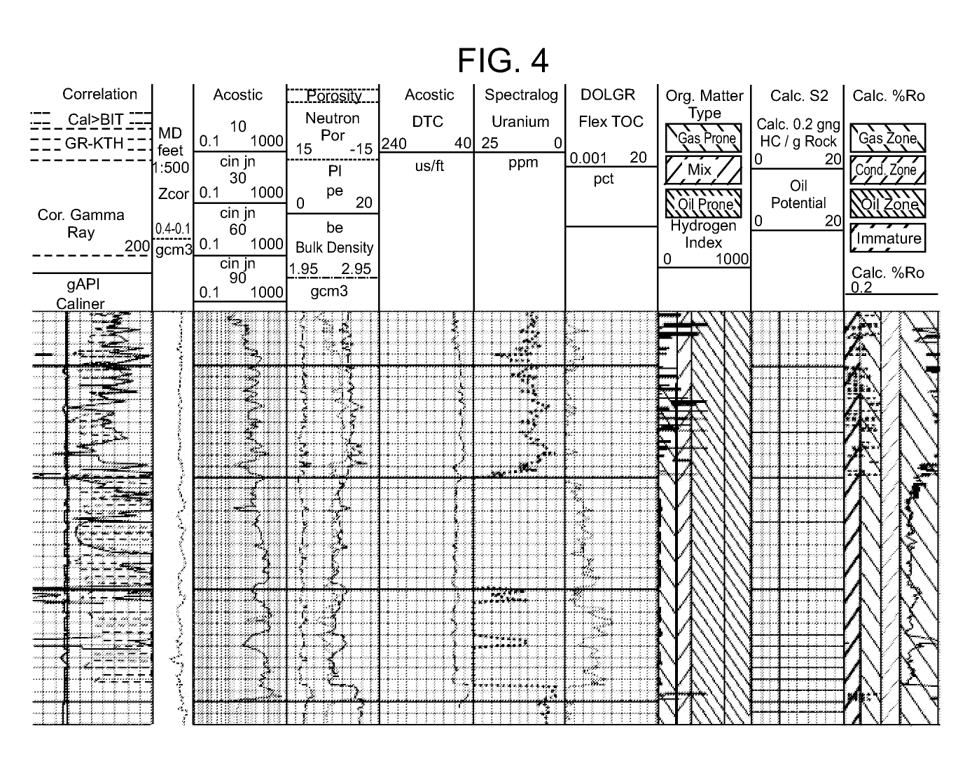

FIG. 3 illustrates a log of Ro for a Barnett Shale section from the oil window shown at Ro log 30. FIG. 4 illustrates a log of Ro for a Woodford Shale section from the dry gas section shown at Ro log 40. In each of the log 30 and the log 40, a graph of the values of Ro is plotted over a background indicating a type of source rock associated with the Ro over the range of logged depths. The types of source rock represented by the background shown in FIGS. 3 and 4 include gas zone, condensate zone, oil zone, and immature zone.

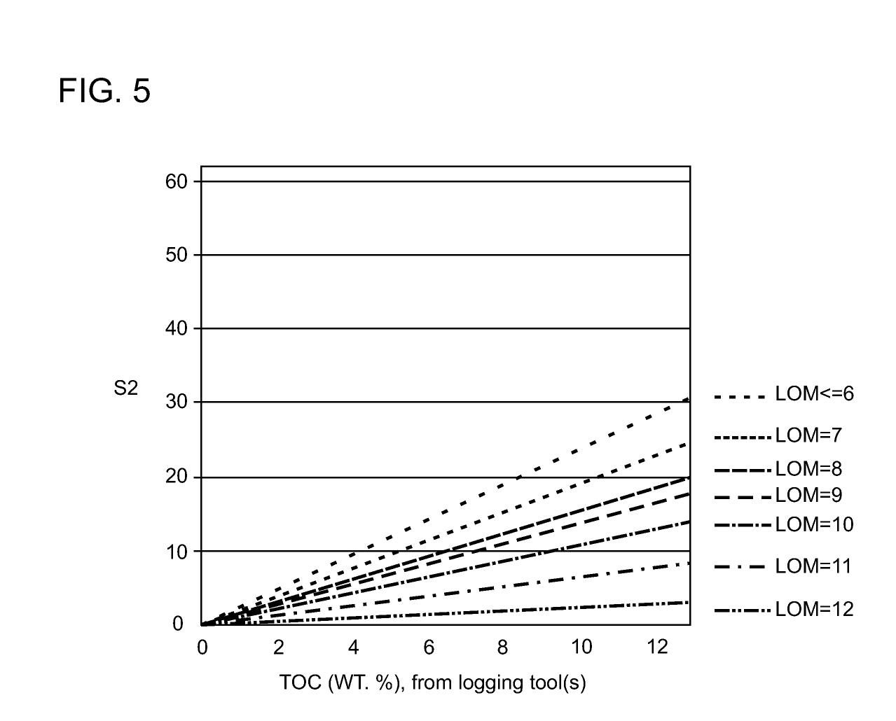

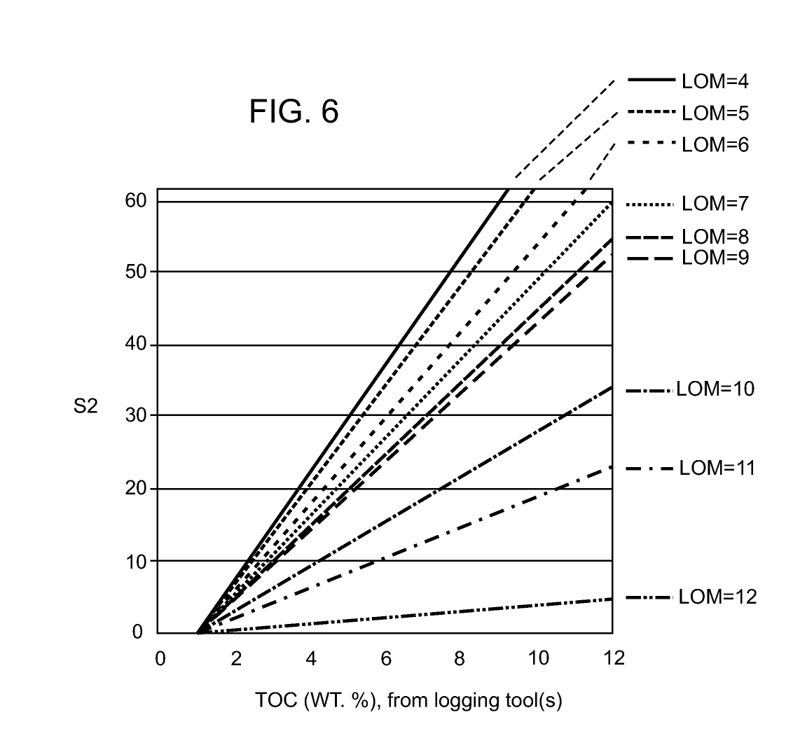

Passey et al. also presented correlations drawn between TOC, LOM and S2 content. S2 is normally measured with pyrolysis on a core sample. The S2 peak corresponds to the temperature when the maximum amount of hydrocarbons is generated. The lower the S2 value, the more hydrocarbons have been expelled from the sample of source rock. S2 is inversely proportional to organic maturity. FIG. 5 presents a correlation between S2 and TOC obtained from the logging tool(s) 10 for gas prone S2. FIG. 6 presents a correlation between S2 and TOC obtained from the logging tool(s) 10 for oil prone S2. Because the TOC of source rock can be determined as function of depth, the S2 of the source rock can also be determined as a function of depth and plotted as a log. An S2 log 31 is shown in FIG. 3 and an S2 log 41 is shown in FIG. 4.

As noted above, the hydrogen index (HI) of source rock can be determined once the TOC and the S2 of the source rock are known. The hydrogen index is defined as the ratio of the S2 in milligram HC per gram of rock to the TOC in weight percent. Since S2 and LOM can each be determined from the TOC derived from output of the logging tool(s) 10, a correlation of between the HI and LOM can be derived from Equation (2). FIG. 7 presents a curve of a correlation between HI and LOM for gas prone source rock. The curve can be represented mathematically by Equation (4).

HI_{gas}=0.2914*LOM⁴−11.64*LOM³+169.57*LOM²−1099*LOM+2863.2 (4)

Similarly, a correlation between the HI and LOM for oil prone source rock can be derived from Equation (2) and is presented in Equation (5).

HIₒᵢₗ=0.1028*LOM⁴−3.94*LOM³+50.4*LOM²−290*LOM+960 (5)

Using correlations between HI and LOM such as those shown in Equations (4) and (5) and knowing that LOM can be determined as a function of depth, HI can be plotted as a function of depth to produce an HI log. An HI log 32 is shown in FIG. 3 and an HI log 42 is shown in FIG. 4. As shown in FIGS. 3 and 4, each of the HI log 32 and the HI log 42, respectively, are plotted against a background indicating an organic matter type associated with the HI. The background for the organic matter types includes oil prone organic matter, gas prone organic matter, and a mix thereof.

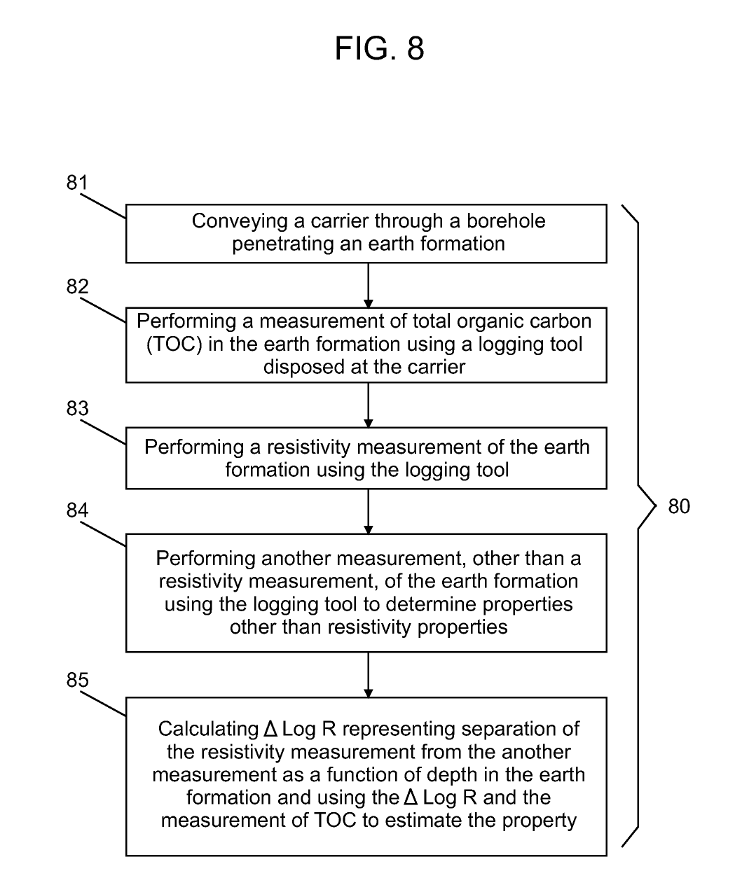

FIG. 8 presents one example of a method 80 for estimating a property such as LOM of the formation 4. The method 80 calls for (step 81) conveying a carrier through the borehole 2 penetrating the formation 4. Further, the method 80 calls for (step 82) performing a measurement of total organic carbon (TOC) in the earth formation using a logging tool disposed at the carrier. The term “measurement” relates to a direct measurement of TOC or an indirect measurement of TOC in which TOC is derived from one or more measured parameters. Further, the method 80 calls for (step 83) performing a resistivity measurement (to determine resistivity/conductivity properties) of the formation 4 using the logging tool. Further, the method 80 calls for (step 84) performing another measurement, other than a resistivity measurement, of the formation 4 using the logging tool to determine properties other than resistivity properties. Further, the method 80 calls for (step 85) correlating the measured TOC, the resistivity measurement, and the another measurement to the property to estimate the property. Step 85 can also include calculating Δ Log R representing separation of the resistivity measurement from the another measurement as a function of depth in the earth formation and using the Δ Log R and the measurement of TOC to estimate the property.

An advantage of the techniques disclosed herein is that a real time log can be produced as the logging tool 10 performs measurements of the formation 4. The real time log can include a log of Ro derived from LOM, S2 derived from LOM, and hydrogen index derived from LOM. These logs can be used as robust qualitative indicators of source rock type and maturity without resorting to the need of extracting a core and analyzing the core in a laboratory.

In support of the teachings herein, various analysis components may be used, including a digital and/or an analog system. For example, the downhole electronics 7 or the surface processing system 8 may include the digital and/or analog system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

The term “carrier” as used herein means any device, device component, combination of devices, media and/or member that may be used to convey, house, support or otherwise facilitate the use of another device, device component, combination of devices, media and/or member. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for estimating a property of an earth formation, the method comprising:
conveying a carrier through a borehole penetrating the earth formation;
performing a measurement of total organic carbon (TOC) in the earth formation using a logging tool disposed at the carrier; and
correlating the measured TOC to the property to estimate the property.

2. The method of claim 1, wherein the property is a level of thermal maturity (LOM).

3. The method of claim 2, wherein a Δ Log R is used with the measured TOC to calculate the LOM, the Δ Log R comprising a measurement of separation between a resistivity measurement of the earth formation and another type of measurement of the earth formation.

4. The method of claim 3, wherein the another type of measurement comprises at least one selection from a group consisting of porosity, density, and acoustic.

5. The method of claim 2, further comprising correlating the LOM to a hydrogen index.

6. The method of claim 2, further comprising estimating a type of hydrocarbon contained within the region of investigation using the LOM.

7. The method of claim 6, wherein the type of hydrocarbon comprises a selection from a group consisting of oil and gas.

8. The method of claim 2, further comprising correlating the LOM and the TOC to S2 for oil hydrocarbons.

9. The method of claim 2, further comprising correlating the LOM and the TOC to S2 for gas hydrocarbons.

10. The method of claim 1, further comprising plotting the property on a log as a function of depth in the borehole.

11. The method of claim 10, wherein the property is a level of thermal maturity represented by a vitrinite reflectance.

12. The method of claim 11, wherein the vitrinite reflectance is plotted for at least one of a gas zone, an oil zone, a condensate zone, and an immature zone.

13. The method of claim 10, wherein the property is a hydrogen index and the hydrogen index is plotted against a background that indicates a kerogen type.

14. The method of claim 13, wherein the kerogen type comprises at least one of gas prone, oil prone, and a mix of gas prone and oil prone.

15. The method of claim 13, wherein the background comprises at least one of a color, shading, and a visual texture to indicate the kerogen type and/or level of thermal maturity.

16. The method of claim 1, wherein the logging tool is configured to measure at least one of natural radiation, uranium, bulk density, radiation due to inelastic scattering of neutrons, and radiation due to thermal capture of neutrons.

17. An apparatus for estimating a property of an earth formation, the apparatus comprising:
a carrier configured to be conveyed through a borehole penetrating the earth formation;
a logging tool disposed at the carrier and configured to perform a measurement of total organic carbon (TOC) within a region of investigation in the earth formation; and
a processor configured to correlate the measurement of TOC to the property to estimate the property.

18. The apparatus of claim 17, wherein the logging tool comprises:
a natural radiation detector configured to measure natural radiation emitted from the earth formation;
a neutron source configured to irradiate the earth formation with neutrons; and
a radiation detector configured to measure neutron-interaction radiation resulting from the irradiating, the neutron-interaction radiation comprising radiation due to inelastic scattering of at least some of the neutrons and radiation due to thermal capture of at least some of the neutrons;
wherein the natural radiation measurement and the neutron-interaction radiation measurement are used to estimate the TOC.

19. The apparatus of claim 17, wherein the logging tool comprises:
a resistivity tool configured to transmit electrical energy into the region of investigation and to receive an electrical signal resulting from the transmitted electrical energy to produce resistivity responses in a resistivity log; and
an acoustic tool configured to obtain acoustic responses from the region of investigation to produce an acoustic log, a natural radiation tool configured to obtain natural radiation measurements from the region of investigation to produce a natural radiation log, a density tool configured to obtain density measurements of the region of investigation to produce a density log, or a porosity tool configured to obtain porosity measurements of the region of investigation to produce a porosity log;
wherein the processor calculates a Δ Log R representing a separation of the resistivity responses from the acoustic responses, the natural radiation measurements, the density measurements, or the porosity measurements as a function of depth in the earth formation, the Δ Log R and the TOC being input to the processor to estimate a level of thermal maturity of the earth formation.

20. The apparatus as in claim 17, wherein the carrier comprises at least one of a wireline, a slickline, a drillstring and coiled tubing.

21. A non-transitory computer-readable storage medium comprising computer-executable instructions for estimating a property of an earth formation by implementing a method comprising:
receiving a measurement of total organic carbon (TOC) in the earth formation using a logging tool conveyed through a borehole penetrating the earth formation; and
correlating the measured TOC to the property to estimate the property.
